(19) United States
(12) Patent Application Publication
(10) Pub. No.: US 2023/0162239 A1
(43) Pub. Date: May 25, 2023

(54) METHOD AND SYSTEM FOR COMMERCE AND ADVERTISING

(71) Applicant: INTERACTIVE OFFERS LLC, Boca Raton, FL (US)

(72) Inventors: JOSEPH LOMBAS, BOCA RATON, FL (US); WESLEY DE SOUZA, BOCA RATON, FL (US); RAFAEL PEREIRA, NEWARK, NJ (US)

(73) Assignee: INTERACTIVE OFFERS LLC, Boca Raton, FL (US)

(21) Appl. No.: 18/152,743

(22) Filed: Jan. 10, 2023

Related U.S. Application Data
(62) Division of application No. 16/454,032, filed on Jun. 26, 2019.

(51) Int. Cl. G06Q 30/0272; G06Q 30/0273; G06Q 30/0241

(52) U.S. Cl. CPC G06Q 30/0272; G06Q 30/0273; G06Q 30/0277

(57) ABSTRACT

In one or more embodiments, a system and method for e-commerce price-per-click marketing and advertising includes establishing delivery windows for publishers to deliver clicks. Clicks desired by an advertiser are posted to a publisher web site portal for publishers to accept. Acceptance by a publisher of a quantity of clicks for delivery establishes a finite delivery window. During a publisher's delivery window, clicks committed for delivery are subtracted from the web site posting. After the delivery window, actual delivered clicks are subtracted and undelivered reserved clicks are added to the quantity of desired clicks; the updated quantity is posted for other publishers to accept.

### TECHNICAL FIELD

The present disclosure relates generally to systems and methods related to online electronic marketing and advertising.

### BACKGROUND

Commerce is increasingly done online. Global online advertising generates hundreds of billions of dollars annually. In one method of advertising, search engines or other website publishers post banners on their websites that advertise other parties' products and services. Advertisers may deal directly with publishers, but in many cases, third party agencies marry advertisers with publishers and help to coordinate marketing campaigns.

The advertiser may pay a price based on the number of impressions, or viewers who visit the website regardless of whether each viewer takes note of the advertisement or not. In this method, the website publisher may bill the advertiser cost-per-thousand (CPM). In another method, the website publisher may bill the advertiser based on the number of times a visitor actually clicks on a hyperlink contained in the advertisement, that is, based on a redirect to the advertiser's own website or other interaction with the advertiser's product or service offering. This latter method, known as a pay-per-click (PPC) or cost-per-click (CPC), represents attention from a person who is searching for or interested in something that the advertiser offers and is accordingly a hot lead.

E-commerce marketing however, is not limited to advertisements placed on publishers' websites. Email and text message advertising is also used to direct attention to an advertiser's product or service. “Push” messaging service is another means to communicate with potential leads. Publishers exist who collect data and generate and maintain large databases of email addresses, cell phone numbers and myriad personal user data that allow selected sets of end-users to be targeted based on the specific requirements of advertisers. These publishers may send large numbers of email, short message service (SMS) text, or push messages for a given marketing campaign to selected persons contained in their databases at the behest of an advertiser. The messages may contain embedded hyperlinks that when clicked by the recipients direct them to advertisers' websites. As with website publishers above, email, text, or push message advertising may be billed as cost-per-thousand messages sent or cost-per-click.

From an advertiser's perspective, cost-per-click is an important metric of the financial success of a marketing campaign. Return on investment is determined both by cost-per-click and the quality of the leads the campaign return. Thus, an advertiser wants to identify and target clicks that are both inexpensive and high quality leads. However, unlike search and display advertising, email and text message marketing faces the issue that once messages have been sent, one cannot turn resulting web traffic on or off; messages are sent, and resulting clicks occur over time thereafter. The number of residual clicks after the initial bulk email, text, or push message blast can be unpredictable, and because of this it is hard to manage a campaign budget, particularly if multiple publishers are sending out campaign advertisements within a short period time.

A few short examples illustrate an advertiser's conundrum: Advertiser Andy initiates and offers an email marketing campaign, and 2000 clicks total are accepted by Publisher Peter and Publisher Paul. If these two publishers cannot fulfill the 2000 click quota, Andy will need to find yet another publisher to fulfill the missing clicks. Publisher Peter sends out a bulk email blast on Monday, and Publisher Paul sends out a bulk email blast on Tuesday. By Friday one of the following scenarios may occur: 1) Campaign total clicks are under budget and a week has been wasted waiting for clicks to come in; or 2) Campaign total clicks are over budget and Andy overspent. Either scenario is bad for the advertiser.

### BRIEF DESCRIPTION OF THE DRAWINGS

Embodiments are described in detail hereinafter with reference to the accompanying figures, in which:

FIG. 1 is a functional block diagram that illustrates an arrangement and method for advertising according to one or more embodiments;

FIG. 2 is a functional block diagram of the web server computer of FIG. 1 according to one or more embodiments;

FIG. 3 is a flow chart diagram illustrating method steps related to communication with advertisers according one or more embodiments;

FIG. 4 is a flow chart diagram illustrating method steps related to communication with publishers and for implementing a publisher delivery window according one or more embodiments;

FIG. 5 is a flow chart diagram illustrating method steps related to communication with an end user target lead according one or more embodiments; and

FIG. 6 is a flow chart diagram illustrating method steps for implementing a publisher delivery window according to one or more embodiments.

### DETAILED DESCRIPTION

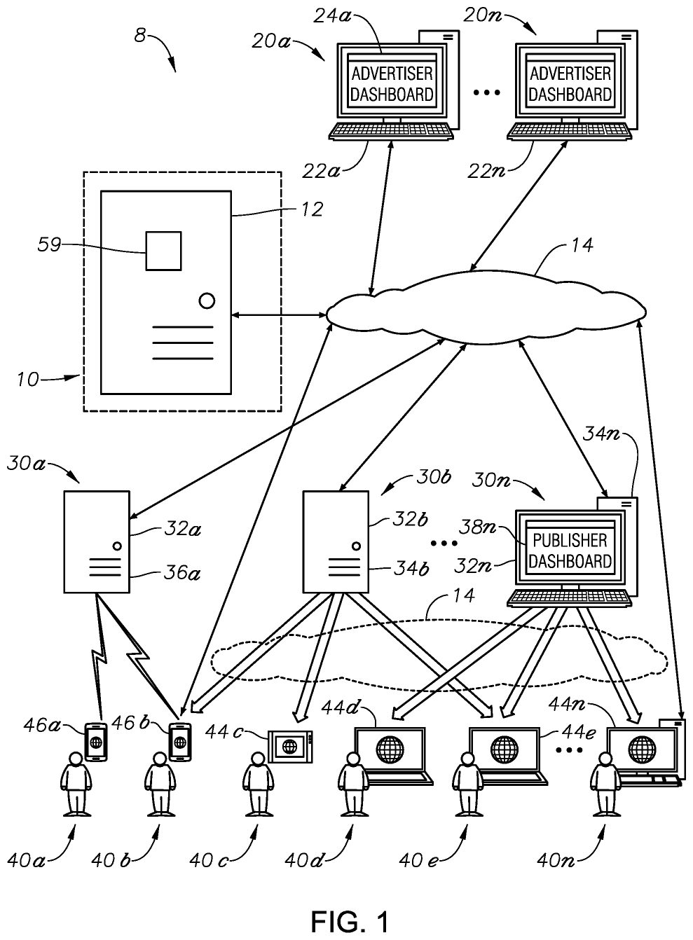

FIG. 1 is a functional block diagram that illustrates an arrangement 8 for advertising according to one or more embodiments. Referring to FIG. 1, a third party agency 10 maintains one or more computer web servers 12 accessible via the internet 14. Advertisers 20a . . . 20n, each having a computer with web browser 22a . . . 22n, may access server 12 via internet 14. Publishers 30a . . . 30n, each having a computer with web browser 32a . . . 32n and an email server 34a . . . 34n or a text message server 36a . . . 36n, may also access server 12 via internet 14. Finally, a plurality of target leads 40a . . . 40n, each having a computer or tablet with web browser 44a . . . 46n or a smart phone 46a . . . 46n with web browser may access server 12 via internet 14. Regardless of the illustration, server 12, advertiser computers 22a . . . 22n, publisher computers 32a . . . 32n, and target lead computers 44a . . . 46n may each fall within the range from a powerful commercial grade computer server to a personal computer or even a handheld tablet, personal digital assistant (PDA), or smart phone, as appropriate for the needs of each user.

Advertisers 20a . . . 20n may contract with agency 10 to effect one or more email, text message or push marketing campaigns. This agreement may be consummated online via computers 22a . . . 22n, internet 14 and server 12. For example, server 12 may receive a hypertext markup language (HTML) page request from computer 22a and respond with HTML code and optionally cascading style sheet (CSS) code or the like that present advertiser 20a with a custom interactive advertiser dashboard 24a. Advertiser 20a may select various options at dashboard 24a to set various parameters of the marketing campaign, such as price per click, allowed publishers, dates of the marketing campaign, total number of clicks for the campaign, number of clicks per day, and target demographics. All the various advertising campaign parameters are selected by advertiser 20a and transmitted via internet 14 to server 12.

Agency 10 posts advertiser marketing campaigns online. Publishers 30a . . . 30n may view available and selected marketing campaigns by sending an HTML page request to server 12 via computers 32a . . . 32n and internet 14. For example, as illustrated in FIG. 1, server 12 responds to the HTML page request from publisher 30n with HTML and CSS code or the like that presents a custom interactive publisher dashboard 38n. At publisher dashboard 38n, publisher 30n can view details of all marketing campaigns of advertisers 20a . . . 20n who have invited publisher 30n to entertain their offers. Publisher 30n may then accept one or more offers, either to fulfill the full amount of requested clicks or only a portion thereof, by transmitting an insertion order to server 12 via internet 14.

Having accepted one or more advertiser marketing campaign offers, publishers 30a . . . 30n transmit email, text or push marketing messages to contacts 40a . . . 40n within their respective databases. For example, as illustrated in FIG. 1, publisher 30a transmits SMS text messages to cell phones 46a, 46b of users 40a, 40b, respectively, via text server 36a and commercial cellular service. Publisher 30b transmits email messages or push messages to smart phone 46b of user 40b, to tablet 44c of user 40c, and to laptop computer 44e of user 40e. Similarly, publisher 30n transmits email or push marketing messages to computers 44d, 44e, and 44n of users 40d, 40e, and 40n, respectively.

When user 40n clicks on a hyperlink contained in an email or push marketing message that was received, the web browser of computer 44n transmits an HTML page request to server 12 via internet 14 that allows server 12 to count the click attributed to publisher 30n and redirect the request to the appropriate advertiser 20a . . . 20n, optionally encoded with data that allows the advertiser to track where the click originated. Similarly, when user 40b clicks on a hyperlink contained in an email or push marketing message that was received from publisher 30b or a SMS text message that was received from publisher 30a, the web browser of smart phone 46b transmits an HTML page request to server 12 via internet 14 that allows server 12 to count the click attributed to the appropriate publisher and redirect the request to the appropriate advertiser 20a . . . 20n, optionally with source metadata contained in the page address.

Server 12 is preferably a high-capacity web server that hosts one or more web server software applications for selectively and securely allowing multiple remote client computer devices 22a . . . 22n, 32a . . . 32n, 44a . . . 44n, and 46a . . . 46n access over the internet for transfer of HTML files and the like. Server 12 preferably has the memory capacity and functional capabilities of at least a powerful desktop computer to support a large number of concurrent processes and maintain high-throughput internet communications, and more preferably still, is sufficiently capable to support several hundred concurrent client connections. As known in the art, server 12 may be equipped with a local display monitor and input keyboard, keypad, and/or input pointing device (not illustrated) for interfacing with a local system administrator.

As is well known in the computer field, server 12 preferably contains a processor which executes instructions retrieved from a memory device to control the reception and manipulation of input data, the transfer of data to other computers, and the output and display of data on output devices. Preferably, a memory bus is used by the processor to access random access memory (RAM), read only memory (ROM), or other memory. Memory is used for storing input data, processed data, and software in the form of instructions for the processor. The processor may be coupled to a peripheral bus to access input, output and storage devices, possibly including a display monitor, removable disc drive (e.g. CD-ROM), hard disk drive, input keyboard, mouse, universal serial bus (USB) device, and network interface. As this general computer technology is commonplace and well understood in the art, it is neither illustrated nor discussed further herein.

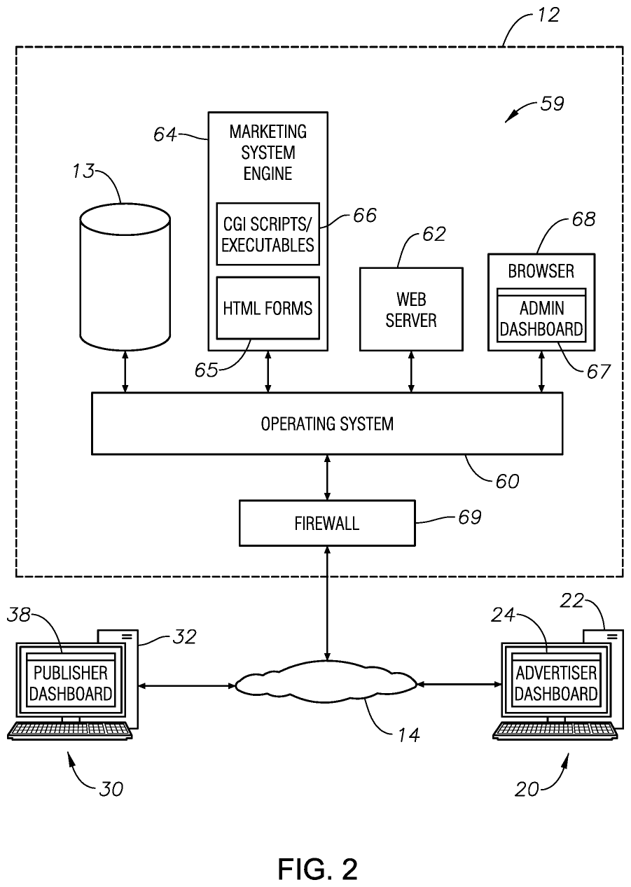

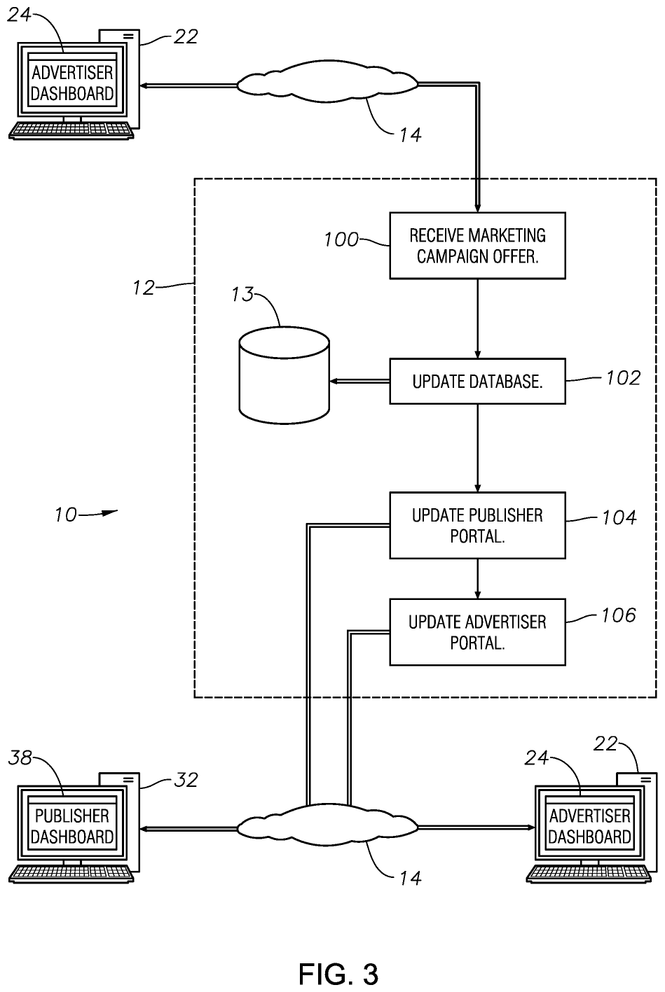

Server 12 includes computer software 59 as an integral part of the system. FIG. 2 is a simplified block diagram that illustrates a basic software configuration of server 12 according to one or more embodiments. Referring to FIG. 2, computer software 59 may include an operating system (OS) 60, a web server application 62, a database 13, and a marketing system engine 64—the custom code written to implement the algorithms of FIGS. 3-6. Software 59 may also include an optional web browser application 68, and an optional network firewall application 69. Computer software 59 may reside in RAM, ROM, hard disk drives, CD-ROMs, other storage media, or combinations thereof. Additionally, software 59 may be stored at a separate computer (not illustrated) and accessed over a network.

Operating system 60, which controls computer resources, peripherals, and the execution of software applications for server 12, is preferably an industry-standard multiuser multitasking web server OS such as an open source Linux® variant. Other appropriate operating systems may also be used. As OS technology is commonplace and well understood in the art, OS 60 is not discussed further herein.

Web sever application 62, which is often bundled with operating system 60, enables users at remote client computer devices 22a . . . 22n, 32a . . . 32n, 44a . . . 44n, and 46a . . . 46n (FIG. 1) to access server 12 to submit marketing campaign offers and insertion order acceptances, view data and reports, count clicks, and process page redirects. Apache is a popular open source hypertext transport protocol (HTTP) web server application that is used with Linux,® Windows® and other operating systems. Utilizing standard ethernet and transmission control protocol/internet protocol (TCP/IP) networking techniques, server 12 is connected to internet 14. With communications managed by web server application 62, server 12 is accessible via a static internet protocol (IP) address from computers having internet access located anywhere in the world. As web server applications are commonplace and well known in the art, web server application 62 is not discussed further herein.

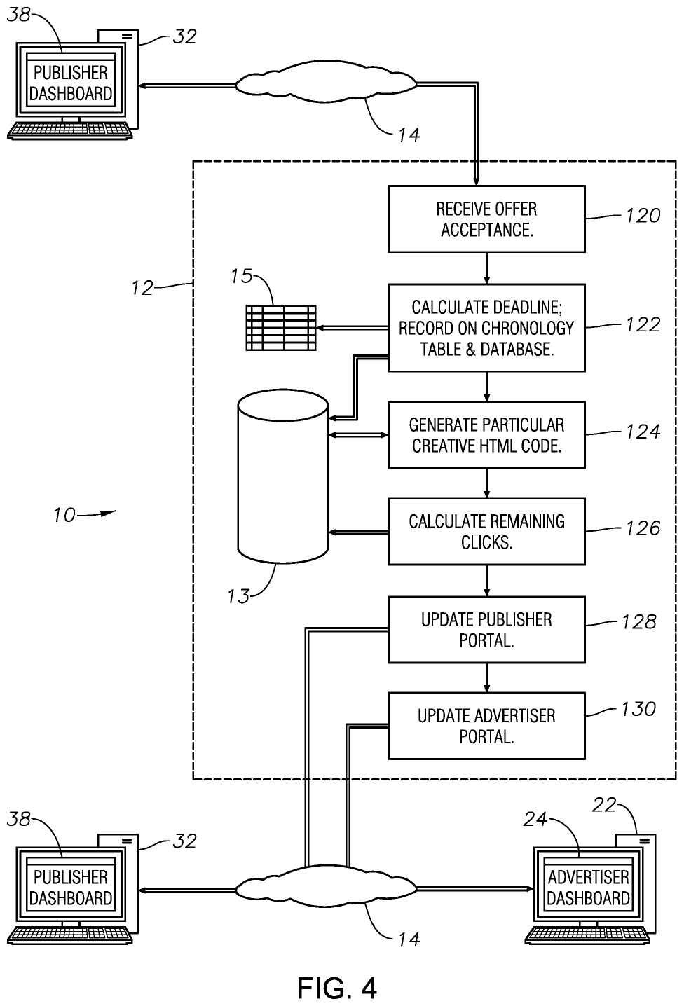

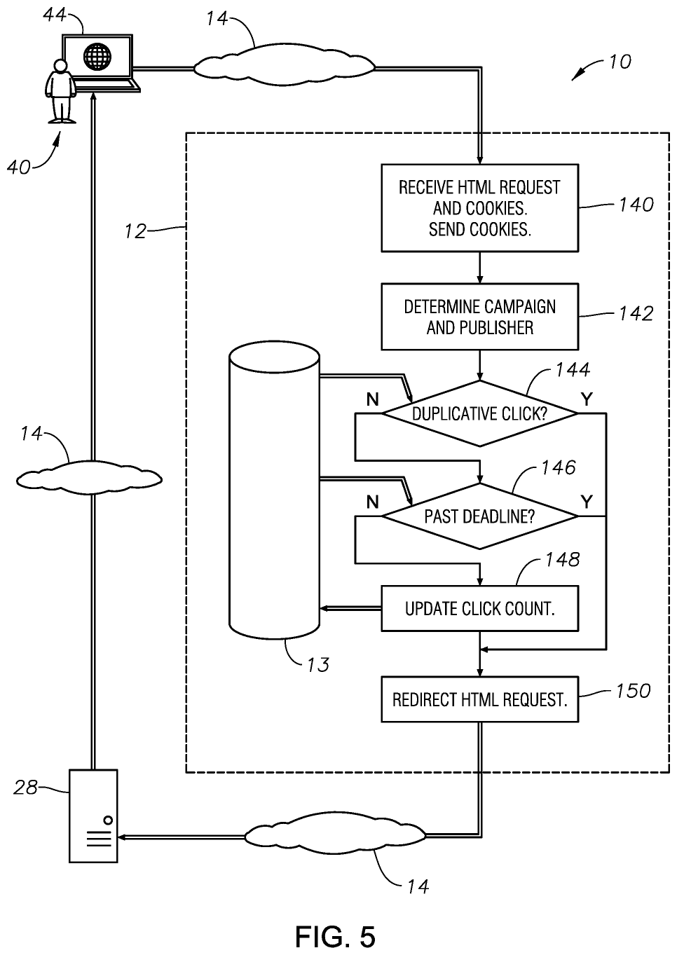

Server 12 stores and manipulates historical and current data associated with advertisers 20a . . . 20n, publishers 30a . . . 30n, and target leads 40a . . . 40n (FIG. 1). As described in greater detail below with respect to FIG. 3, advertiser data may include campaigns (types, dates, publishers, requested clicks, delivered clicks, CPC, and creatives), allowed publishers, accounts receivable, and other performance indicia and metrics. Similarly, as described below with respect to FIG. 4, publisher data may include campaigns (types, dates, advertisers, accepted clicks, delivered clicks, price per click, revenue, and particular creatives), accounts payable, and other performance indicia and metrics. Target lead data may include cookies, IP addresses, publishers, and advertisers, as described in greater detail with respect to FIG. 5. Accordingly, server 12 may include database 13 in order to simplify the organization and handling of the large amount of collected data. In one embodiment, server 12 also functions as a database server for database 13 in addition to its role as a web server. However, with a large number of concurrent client connections, to enhance scalability and performance it may be preferable to host database 13 on a dedicated database server (not illustrated).

Database 13 may be implemented using a common database application suite. In one or more embodiments, database 13 employs a relational database model, in which data is organized in the form of tables. The relational data model was introduced in 1970 by E. F. Codd of International Business Machines IBM, and it has continued to evolve. Relational databases are organized around a mathematical theory that aims to maximize flexibility. The relational data model consists of three components: A data structure wherein data are organized in the form of tables; means of data manipulation for manipulating data stored in the tables, e.g. structured query language (SQL); and means for ensuring data integrity in conformance with business rules. Many relational database management systems (RDBMS) exist, such as Oracle,® MySQL and DB® from IBM. Relational database systems offer scalability and architectural flexibility to provide robust database solutions that perform, adapt and respond to today's business initiatives. Most modern database software is full-featured, robust, scalable and easy to use.

Database 13 may also be implemented using a non-relational methodology, including flat files and legacy database applications, such as IBM's IMS or Computer Associates' IDMS. IMS is a hierarchical database, and IDMS uses the network database model. Unlike relational databases which are designed for flexibility, IMS and IDMS put a premium on performance over flexibility.

For example, IMS's hierarchical approach puts every item of data in an inverted-tree structure, extending downward in a series of parent-child relationships. This approach provides a high-performance path to a given datum. The IDMS network database model allows for more complex, overlapping hierarchies, but falls short of the flexibility of a true relational database system. As database design and programming is well known to routineers in the art, further detail of database 13 is omitted for the sake of brevity.

Web server 12, running web server application 62, functions by listening for connections made by authorized client computers 22, 32 over internet 14 and thereafter by transmitting selective data between computers 22, 32 and server 12. Marketing system engine 64 is a suite of custom software programs and files that work hand-in-hand with web server application 62 to implement the marketing method according to one or more embodiments of the invention. Additionally, marketing system engine 64 and web server application 62 together generate interactive dynamic advertiser dashboards 24, publisher dashboards 38, and optionally a local administrator dashboard 67 that may accessed via web browser 68 for administration of system 8 (FIG. 1). Marketing system engine 64 communicates with database 13 to store, access, and manipulate data as described below with respect to FIGS. 3-6.

In one or more embodiments, marketing system engine 64 preferably includes a family of hyperlinked HTML form files 65 disposed in a web page directory accessed by web server application 62, and a series of Common Gateway Interface (CGI) shell scripts or compiled programs 66, disposed in a cgi-bin or like directory, that are selectively executed in order to transform the otherwise static HTML form files 65 into dynamic user dashboards 24, 38, 67 when displayed in web browsers.

Dashboards 24, 38, 67 ideally employ standard windows-type display and control mechanisms including windows, client windows, frames, flexboxes, icons, buttons, check boxes, radio buttons, scroll bars, drop-down menus, pull-down menus, tabs, bar graphs, panes, panels, forms, slide bars, selection boxes, dialog boxes, text boxes, list boxes, menu bars, bar graphs, wizards, et cetera. The selection and layout of the user interface components, and the placement thereof, may vary widely within the scope of the present disclosure and may optionally be customized by each user. Ideally, dashboards 24, 38, 67 employ responsive site design techniques so as to automatically adjust layout and design to be readable and usable at any screen width. As user interface programming and design are well known in the art, further detail is omitted.

Web server application 62 and marketing system engine 64 cooperate to provide secure remote internet access to server 12. Server 12 provides initial login access to a remote client computer via an initial or default HTML file that prompts the user for a username and password or other identifier. Advertiser 20 may log into an advertiser portal and thereby obtain advertiser dashboard 24 that is populated with that advertiser's custom data. Similarly, publisher 30 may log into a publisher portal and thereby obtain publisher dashboard 38 that is populated with that publisher's custom data.

Marketing system engine 64 may collect data for analysis, retrieve, store, organize, and process that data in real time, and may provide downloadable reports compatible with off-the-shelf software products such as Excel,® Word,® Access,® etc. Marketing system engine 64 may generate and make available a myriad of reports from the collected data, allowing a user to query and format marketing data and graphically display trends with tremendous flexibility, as described in greater detail below.

Server 12 may include a network firewall 69 to protect it from unauthorized intrusion and computer hacking efforts. Firewall 69 may be a firewall software application executed by server 12 as illustrated, or it may be a discrete and independent hardware firewall operatively coupled between the network interface server 12 and internet 14 (not illustrated). Regardless of the type of firewall 69 installed, firewall 69 is preferably commercial off-the-shelf and provides controlled access to server 12 using multiple recognized network security methods such as user and password challenges, VPN access, filtered IP address access, et cetera. In other words, server 12 is secured to eliminate unauthorized access the same way that an ordinary computer is protected using existing or future common network security products. As network firewalls are well known in the art, further detailed discussion is omitted.

Although the embodiments of FIGS. 1 and 2 are described with respect to SMS text messages, email and push messages, a routineer would recognize that multimedia messaging service (MMS) text messages, dynamic emails, and similar means of communicating with a user, either extant or yet to be developed, may by used as appropriate. Further, marketing messages may be dedicated for a particular advertiser 20a . . . 20n or may be co-registered, that is, may be comingled with marketing material from more than one advertiser. Moreover, the embodiment is not limited to the use of HTML and CSS coding; XML, PHP, Java, and/or other appropriate coding schemes, either extant or yet to be developed, may be used as known in the art. Finally, although the embodiments of system 8 described herein employ TCP/IP communication techniques, the present disclosure is not limited to using this format. New communication formats and protocols may be developed over time which may replace existing formats, and system 8 preferably employs technologies consistent with the internet standards in use at any given time.

FIGS. 3-6 are flow chart diagrams that outline a method of marketing according to one or more embodiments. These figures employ a standard flow chart convention where decisions are represented by a rhomboidal symbol and actions are represented by a rectangular symbol. The program logic flow between the various decisions and actions is depicted by single-lined arrows. For instance, each decision rhombus contains an interrogatory. If the interrogatory, when evaluated, is true or yes, the program flow is indicated by the arrow leading from that rhombus designated with a “Y.” Likewise, if the interrogatory is false or no, the program flow is indicated by the arrow leading from that rhombus labeled with an “N.”

FIG. 3 is a flow chart diagram illustrating steps performed by third party agency 10 related to communication with advertisers according one or more embodiments. Referring to FIG. 3, at step 100, a campaign offer, defined by the detailed parameters associated with a particular marketing campaign, is received by server 12 from an advertisers computer 22 via internet 14. In particular, as described above with respect to FIG. 1, server 12 receives an advertiser portal HTML page request from computer 22 and responds with HTML and CSS code or the like that presents a custom interactive advertiser dashboard 24. Options are selected or specified at dashboard 24 to set various parameters of the marketing campaign, such as price per click, allowed publishers, dates of the marketing campaign, total number of clicks for the campaign, number of clicks per day, and target demographics. Additionally, creatives (i.e., the format of one or more marketing messages, including subject lines, text, graphics, images, and arrangement thereof), as well as the destination web page upon click, are transmitted to server 12 at step 100. Along with receiving the marketing campaign offer, step 100 may include receiving funds in advance for the campaign, such as by online credit card transaction.

At step 102, the parameters of the advertising campaign are written to a database 13 by server 12. At step 104, any active sessions at the publisher portal, described in greater detail infra, are updated to reflect and display the new advertising campaign, which publishers can accept. Data describing the advertising campaign are displayed at a publisher dashboard 38 on a publisher computer 38 as described in greater detail below.

Finally, at step 106, the corresponding advertiser dashboard 24 at computer 22 is updated to reflect the new marketing campaign. For the new campaign, dashboard 24 ideally displays price per click, allowed publishers, dates of the marketing campaign, total number of clicks purchased for the campaign, number of allowed clicks per day, target demographics, and destination web page. Additionally, creatives—the formats of marketing messages, including subject lines, text, graphics, images, and arrangement thereof—are also viewable at dashboard 24. For all currently active and past campaigns, dashboard 24 also displays publishers who have accepted the offer, number of clicks agreed to and number actually supplied, total dollars spent and average cost per click for all campaigns. Other useful metrics and statistical analysis may also be displayed that enable the advertiser to analyze the quality of the clicks (e.g. the percentage of clicks that result in a sale) for each publisher and overall rate of return on their investment.

Not all of the above data is necessarily displayed on the dashboard at one time. Buttons and other interactive HTML tools may be provided that allow the advertiser to select what data is displayed at any given time. Functionality to filter and sort data, for example, selecting discrete periods of time or only text message campaigns, et cetera, is preferably provided. A calendar display and graphical displays may be provided.

FIG. 4 is a flow chart diagram illustrating steps performed by third party agency 10 related to communication with publishers according one or more embodiments. Referring to FIG. 4, at step 120, an offer acceptance, or insertion order, is received by server 12 from a publishers computer 32 via internet 14. In particular, as described above with respect to FIG. 1, server 12 receives a publisher portal HTML page request from computer 32 and responds with HTML and CSS code or the like that presents a custom interactive publisher dashboard 38. Publisher portal 38 displays information outlining all available advertiser campaigns for which that publisher has been invited to entertain, including campaign type (e.g., text message, dedicated email, etc.), total clicks available, dates of campaign, allowed clicks per day, and creatives. The publisher may accept one or more offers from one or more advertisers using publisher portal 38. For each accepted offer, the publisher may accept the total number of clicks requested by the advertiser or an amount less than the total number of clicks requested. If the advertiser provides more than one creative, the publisher may choose the creative that best suits its platform.

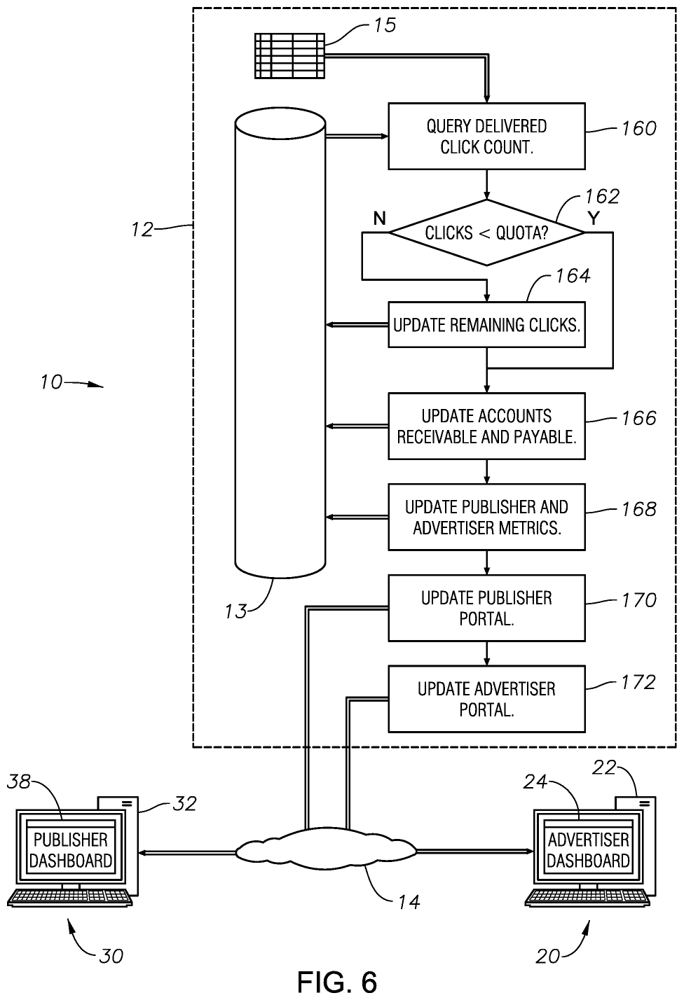

Once an offer acceptance is received by server 12, at step 122 a click delivery window deadline is calculated. Step 122 mitigates a traditional challenge to automating traditional insertion order marketing campaigns. After a bulk marketing message blast is sent, most of the clicks occur within a few hours. After that, a few residual clicks will trickle in for a number of weeks. To provide predictability for the advertiser, during the delivery window the click quota reserved by the publisher is subtracted from the advertisers campaign budget. The remaining clicks continue to be available for other publishers to accept. As discussed infra with respect to FIG. 6, after the delivery window deadline passes, undelivered clicks are made available for other publishers to accept.

According to one or more embodiments, a 24-72 hour delivery window is established from the commencement date for click delivery set by the advertiser. For example, a 48 hour delivery window may be established; in the case that the publisher accepts an advertiser's offer after the commence date has begun, the deadline may be set at 48 hours from midnight of that day to allow the publisher time to send out marketing messages without penalty. However, other reasonable finite delivery window time periods may be established within the scope of the present disclosure.

At step 122, the calculated delivery window deadline is recorded to trigger activation of the steps of FIG. 6. In one embodiment, the deadline is recorded in a chronology table 15 that causes the server operating system to execute a process at the specified time. The Linux® operating includes this feature using the CRON command and CRONTAB file. However, other methods to implement automatic triggering of the steps of FIG. 6 may be used as known to routineers of the art.

At step 124, a creative HTML code is generated that is particular to each publisher for each marketing campaign for inclusion in the marketing messages that it sends out. It may be simply displayed in a dialog box in publisher dashboard 38 (at step 128) and cut and pasted by the publisher into the publisher's outgoing messages. The creative HTML code is based on the creative supplied by the advertiser and chosen by the publisher, described supra. The portion of the particular creative HTML code that defines the hyperlink that a target lead is intended to click is modified by server 12 to include metadata that allows server 12 to later ascertain the advertiser, marketing campaign, publisher and delivery window deadline when the hyperlink is clicked by a lead. Upon clicking this hyperlink, this creative HTML code is processed by server 12 as described below with respect to FIG. 5.

Because a publisher may accept an advertiser's offer for fewer clicks than requested, at step 126, the number of unaccepted clicks is calculated. These unaccepted clicks remain available for other publishers to accept. At step 128, the publisher portal is updated, which is reflected in each active publisher dashboard 38. For the publisher that just accepted an advertiser's offer, dashboard 38 displays the parameters of the accepted offer, as well as parameters for other active campaigns the publisher has accepted. For other current publisher portal sessions, dashboard 38 is updated to reflect the decrease in available clicks by the number of clicks reserved by the accepting publisher.

Additionally, publisher portal 38 may display other metrics, including the number of clicks captured and capture time for each campaign, and dollars earned. Not all of the above data is necessarily displayed on the dashboard at one time. Buttons and other interactive HTML tools may be provided to allow the advertiser to select what data is displayed at any given time, whether it be marketing campaigns available for acceptance, current campaign performance, or historical data. Functionality to filter and sort data, for example, selecting discrete periods of time or only text message campaigns, etc., is preferably provided. A calendar display and graphical displays may be provided.

At step 130, if an advertiser whose offer has been accepted is currently logged into the advertiser portal of server 12, advertiser dashboard 24 may be updated in real time to reflect the changes. Specifically, dashboard 24 will show that the particular publisher has accepted a number of clicks and the number of available clicks remaining for other publishers to accept.

FIG. 5 is a flow chart diagram illustrating steps performed by third party agency 10 related to communication with an end user target lead upon clicking a hyperlink contained in a received marketing message according one or more embodiments. Referring to FIG. 5, at step 140, an HTML page is received by server 12 from computer 44 of target lead 40 via internet 14. This HTML page request results from lead 40 clicking a hyperlink contained in in the particular creative HTML code generated by server 12 at step 124 of FIG. 4, which was received by lead 40 in an email, text or push message, for example.

If lead 40 previously clicked on a hyperlink that submitted an HTML page request to server 12, regardless of the campaign, advertiser, or publisher associated with that hyperlink, server 12 may have written cookies to lead computer 44. If such cookies exist on computer 44, they will be automatically transmitted by the computer 44 along with the present HTML page request. Regardless of whether previously created cookies are transmitted to server 12, server 12 may optionally transmit new cookies to computer 44 in response to the current HTML page request. Cookies may be used by server 12 for a variety of purposes, including fraud detection, data mining reflecting shopping interests of lead 40, and discernment of multiple duplicate clicks from a given marketing message.

At step 142, the publisher, advertiser, and campaign are determined by server 12 using metadata contained in the received HTML page request. That is, the particular creative HTML code established in step 142 of FIG. 4 includes the metadata in the hyperlink that allows server 12 to ascertain the publisher, advertiser, and campaign.

At step 144, server 12 determines whether the click is duplicative, i.e., whether user 40 has clicked multiple times on the received hyperlink. In one or more embodiments, this determination may be made by identifying user 40, which may include determining the IP address of computer 44, meta hashing techniques, and tracking internet sessions. This data is stored in database 13, and database 13 is queried to determine if a click was previously recorded. Cookies, if any, received with the HTML page request, may also aid in determining duplicative clicks. Any suitable techniques to identify duplicative clicks, either now extent or yet to be developed, may be used within the scope of the disclosure. If server 12 determines that the click is duplicative, the click is not recounted and program flow proceeds to step 150; otherwise, program flow proceeds to step 146.

At step 146, server 12 determines if the click was received after the delivery window deadline that was established for that publisher (step 122 of FIG. 4) has passed. If so, the click is not counted and program flow proceeds to step 150; otherwise, at step 148 database 13 is updated to reflect the click. Metrics and other relevant data may be updated and reflected in any currently active dashboards.

Finally, at step 150, the HTML page request is appropriately redirected to advertiser web server 28 at the destination web address specified by the advertiser (step 100 of FIG. 3). Server 12 may reformat the destination address, adding source metadata that the advertiser may use for internal tracking purposes. Accordingly, when lead 40 clicks the hyperlink contained in a received marketing message, in a method that is essentially transparent to lead 40, the click is appropriately counted by server 12, and advertiser web server 28 transmits a desired web page to lead 40.

FIG. 6 illustrates a method for implementing the publisher delivery window deadline according to one or more embodiments. Step 160 is initiated at the expiration of each delivery window. The operating system of server 12 may automatically initiate step 160 at each deadline using the CRON function and chronology table 15. However, other methods for initiating step 160 may be used as known to those skilled in the art.

At step 160, server 12 queries database 13 to determine the number of clicks that have been counted resulting from the publisher's marketing efforts. These clicks have been recorded in database 13 as described above with respect to step 148 of FIG. 5. At step 162, sever 12 determines whether the delivered clicks met the accepted quota or fall short of the quota. If the delivered clicks satisfy the quota, program flow proceeds to step 166; otherwise, at step 164, database 13 is updated to make the undelivered clicks available to other publishers to accept.

At steps 166 and 168, accounts receivable and payable and publisher and advertiser data and metrics are updated, respectively. Finally, at steps 170 and 172, any current publisher and advertiser portal sessions, respectively, are updated to reflect the current status in active dashboards.

In one or more embodiments, after a publisher has accepted a given marketing campaign offer, that publisher may be prohibited from a second acceptance of that marketing campaign offer. For instance, after the publisher's delivery window deadline has passed and undelivered clicks are reposted for acceptance, that publisher may not transmit another acceptance. This feature prevents publishers from circumventing the delivery window deadline in an attempt to capture lagging clicks.

In summary, to illustrate the method of FIGS. 3-6, advertiser Andy posts a marketing campaign offer for 2000 total clicks. Publisher Peter accepts the offer for 1000 clicks for delivery commencing Monday. Thereafter, publisher Paul sees on his dashboard 1000 available clicks and accepts the offer for the remaining 1000 clicks for delivery commencing Tuesday. On Wednesday, following the delivery window deadline expiration for publisher Peter, the current click count—2000 requested clicks less the actual number of counted clicks from publisher Peter and the 1000 clicks reserved by publisher Paul—is updated for other publishers to entertain. On Thursday, following the delivery window deadline expiration for publisher Paul, the current click count—2000 offered clicks less the actual number of counted clicks from publisher Peter and actual number of counted clicks from publisher Paul—is updated for other publishers to entertain. In this manner, the method according to one or more embodiments sets publisher delivery deadlines and updates server 12 accordingly that allows other publishers to view and accept available offered clicks along the way according to what is currently available on the campaign budget. The advertiser is thereby protected from both far exceeding budget and wasting time for residual licks to trickle in long after bulk messaging has occurred.

The present invention may be embodied in part as computer readable code on computer readable media, including any computer data storage device such as magnetic storage devices, optical storage devices or ROM storage devices. The computer readable code may also be distributed over a network between computer systems so that it is stored and executed in a distributed fashion.

The Abstract of the disclosure is solely for providing the a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the invention.

1. A marketing method comprising the steps of:
receiving a web page request;
determining a redirect internet address from said request;
determining from said request a publisher associated with said request;
determining whether said request was received within a delivery window established for said publisher;
determining whether said request is duplicative;
counting said request if received within the delivery window and non-duplicative; and
redirecting the request to said redirect internet address.

2. The method of claim 1 wherein:
said request results from a click of a hyperlink included in a message sent by said publisher.

3. The method of claim 1 further comprising the steps of:
receiving from said publisher a commitment for a quantity of clicks for delivery; and
establishing said delivery window for said publisher as a period of time following the reception of said commitment.

4. The method of claim 3 further comprising the step of:
establishing said delivery window for a period of time ranging from 24 hours to 72 hours

5. The method of claim 3 further comprising the step of: establishing said delivery window for a 48 hour period of time.

6. The method of claim 1 further comprising the steps of: receiving from an advertiser an offer for a desired quantity of clicks; posting said offer for the desired quantity of clicks on a publisher portal;
updating said posting for the desired quantity of clicks less a quantity of clicks reserved for delivery; and
after the delivery window, updating said posting for the desired quantity of clicks less counted web page requests.

7. A marketing method comprising the steps of:
receiving from an advertiser an offer for a quantity of desired clicks;
displaying to a plurality of publishers a balance of clicks being offered by said advertiser equal to said quantity of desired clicks less a total of reserved clicks and a total of delivered clicks;
receiving from a first publisher a first acceptance of said offer for a quantity of clicks to be delivered;
adding said quantity of clicks to be delivered by said first publisher to said total of reserved clicks and updating said balance of clicks being offered;
establishing a first delivery window deadline for said first publisher;
counting a quantity of clicks actually delivered by said first publisher prior to the first delivery window deadline; and
after the first delivery window deadline, adding the quantity of clicks actually delivered by said first publisher to the total of delivered clicks, subtracting the quantity of clicks to be delivered by said first publisher from the total of reserved clicks, and updating said balance of clicks being offered.

8. The method of claim 7 further comprising the step of:
refusing a second acceptance of said offer from said first publisher.

9. The method of claim 7 wherein;
said quantity of clicks to be delivered by the first publisher is less than the balance of clicks being offered at the moment of said step of receiving from the first publisher the first acceptance.

10. The method of claim 9 further comprising the steps of:
receiving from a second publisher a second acceptance of said offer for a quantity of clicks to be delivered;
adding said quantity of clicks to be delivered by said second publisher to said total of reserved clicks and updating said balance of clicks being offered;
establishing a second delivery window deadline for said second publisher;
counting a second delivery window deadline for said second publisher;
counting a quantity of clicks actually delivered by said second publisher prior to the second delivery window deadline; and
after the second delivery window deadline, adding the quantity of clicks actually delivered by said second publisher to the total of delivered clicks, subtracting the quantity of clicks to be delivered by said second publisher from the total of reserved clicks, and updating said balance of clicks being offered.

11. The method of claim 7 further comprising the step of:
establishing said first delivery window deadline to be a time falling within the range of 24 to 72 hours following the step of receiving from the first publisher the first acceptance.

12. The method of claim 11 further comprising the step of:
establishing said first delivery window deadline 48 hours following the step of receiving from the first publisher the first acceptance.

13. The method of claim 7 wherein said step of counting further includes the steps of:
receiving a plurality of web page requests;
counting said plurality of web page requests; and
redirecting said plurality of web page requests to an internet address specified by said advertiser.

14. A marketing system comprising:
a computer server coupled via the internet to an advertiser computer, a plurality of publisher computers, and a plurality of lead computers;
said computer server adapted to receive from said advertiser computer an offer for a quantity of desired clicks;
said computer server adapted to selectively post to said plurality of publisher computers an offer for a balance of clicks equal to said quantity of desired clicks less a total of reserved clicks and a total of delivered clicks;
said computer server adapted to receive from a first of said plurality of publisher computers a first acceptance of said offer for a quantity of clicks to be delivered by a first publisher;
said computer server adapted to add said quantity of clicks to be delivered by said first publisher to said total of reserved clicks and to update and post said balance of clicks being offered;
said computer server adapted to establish a first delivery window deadline for said first publisher;
said computer server adapted to count a quantity of clicks actually delivered by said first publisher prior to the first delivery window deadline; and
said computer server adapted to, after the first delivery window deadline, add the quantity of clicks actually delivered by said first publisher to the total of delivered clicks, subtract the quantity of clicks to be delivered by said first publisher from the total of reserved clicks, and update and post said balance of clicks being offered.

15. The system of claim 14 wherein:
said computer server is adapted to refuse a second acceptance of said offer from said first publisher.

16. The system of claim 14 wherein:
said quantity of clicks to be delivered by the first publisher is less than the balance of clicks at the moment of receiving from the first publisher the first acceptance.

17. The system of claim 16 wherein:
said computer server is adapted to receive from a second of said plurality of publisher computers a second acceptance of said offer for a quantity of clicks to be delivered by a second publisher;
said computer server is adapted to add said quantity of clicks to be delivered by said second publisher to said total of reserved clicks and update and post said balance of clicks being offered;
said computer server is adapted to establish a second delivery window deadline for said second publisher;
said computer server is adapted to count a quantity of clicks actually delivered by said second publisher prior to the second delivery window deadline; and
said computer server is adapted to, after the second delivery window deadline, add the quantity of clicks actually delivered by said second publisher to the total of delivered clicks, subtract the quantity of clicks to be delivered by said second publisher from the total of reserved clicks, and update and post said balance of clicks being offered.

18. The system of claim 14 wherein:
said computer server is adapted to establish said first delivery window deadline to be a time falling within the range of 24 to 72 hours following the reception from the first publisher computer of the first acceptance.

19. The system of claim 18 wherein:
said computer server is adapted to establish said first delivery window deadline 48 hours following the reception from the first publisher computer of the first acceptance.

20. The method of claim 14 wherein:
said computer server is adapted to receive a plurality of web page requests from said plurality of lead computers;
said computer server is adapted to count said plurality of web page requests; and
said computer server is adapted to redirect said plurality of web page requests to an advertiser internet address.

21. A system for marketing comprising automated computing machinery stored in a computer readable non-transitory medium configured for:
receiving a web page request;
determining a redirect internet address from said request;
determining from said request a publisher associated with said request;
determining whether said request was received within a delivery window established for said publisher;
determining whether said request is duplicative;
counting said request if received within the delivery window and non-duplicative; and
redirecting the request to said redirect internet address.

22. The system of claim 21 wherein:
said request results from a click of a hyperlink included in a message sent by said publisher.

23. The system of claim 21 further configured for:
receiving from said publisher a commitment for a quantity of clicks for delivery; and
establishing said delivery window for said publisher as a period of time following the reception of said commitment.

24. The system of claim 23 further configured for:
establishing said delivery window for a period of time ranging from 24 hours to 72 hours.

25. The system of claim 23 further configured for: establishing said delivery window for a 48 hour period of time.

26. The system of claim 21 further configured for:
receiving from an advertiser an offer for a desired quantity of clicks;
posting said offer for the desired quantity of clicks on a publisher portal;
updating said posting for the desired quantity of clicks less a quantity of clicks reserved for delivery; and
after the delivery window, updating said posting for the desired quantity of clicks less counted web page requests.
